(19) United States
(12) Patent Application Publication
(10) Pub. No.: US 2004/0113129 A1
(43) Pub. Date: Jun. 17, 2004

(54) Static dissipative thermoplastic polymer composition

(76) Inventors: Marion G. Waggoner, Landenberg, PA (US); William J. Hassink, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/616,188

(22) Filed: Jul. 9, 2003

Related U.S. Application Data
(60) Provisional application No. 60/398,545, filed on Jul. 25, 2002.

(51) Int. Cl. H01B 1/00

(52) U.S. Cl. 252/500

(57) ABSTRACT

Static dissipative compositions containing thermoplastic polymers and having surface resistivities of about 10⁴ to 10¹³ ohms/square can be readily and reproducibly made by mixing into the thermoplastic polymers specified amounts of carbon fiber and carbon black. The composition is useful for housings and other parts for shielding electronic equipment and components.

### CROSS REFERENCE TO RELATED APPLICATION

This application claims the benefit of U.S. Provisional Application No. 60/398,545, filed Jul. 25, 2002.

### FIELD OF THE INVENTION

Thermoplastic polymer compositions having static dissipative properties contain specified amounts of carbon fibers and carbon black.

### TECHNICAL BACKGROUND

Thermoplastic polymers are versatile materials which can be molded into varied and complex shapes. The great majority of such polymers do not conduct electricity and in fact are good electrical insulators. However addition of sufficient amounts of electrically conductive fillers to these polymers usually yields a composition which has (some) electrical conductivity. Between these two extremes, the addition of intermediate amounts of conductive filler, to give a surface resistivity of about 10⁴ to about 10¹³ ohms/square, results in compositions which are still relatively insulating, but which readily dissipate static electricity, which makes them valuable for components in contact with or near electronic equipment. Such compositions are also useful for electromagnetic interference (EMI) shielding.

As described in U.S. Pat. No. 5,820,788, and references described therein, carbon fibers have been used as the conductive fillers in such compositions. However, the exact surface resistivity of the composition depends on (among other items) the exact nature and amount of the carbon fiber used and the (average) lengths of those fibers. The lengths are difficult to control during melt processing of such compositions, and so it is difficult to produce material within a certain surface resistivity range. The invention of U.S. Pat. No. 5,820,788 solved this problem by using carbon fibers with reduced carbon contents and hence reduced electrical conductivities, but this has the disadvantage of requiring special carbon fibers, and different carbon fibers to attain different surface resistivities. Thus new ways making static dissipative polymeric compositions reproducibly are needed.

European Patent Application 1,061,597 describes thermoplastic polymer compositions containing carbon black and carbon fibers. None of the compositions actually reported contain these fillers in the range claimed herein.

### SUMMARY OF THE INVENTION

This invention concerns a composition, comprising, a thermoplastic polymer, about 5.0 to about 10 volume percent of carbon fiber, and about 8 to about 25 volume percent of carbon black, wherein said volume percentages are based on the total volume of said composition.

### DETAILS OF THE INVENTION

The composition herein contains a thermoplastic polymer. Such polymers may be reformed by melting the thermoplastic and then cooling it below its melting point and/or glass transition temperature. Such polymers are not crosslinked. Generally they have a melting point and/or glass transition temperature above 30° C., when measured by differential scanning calorimetry, with the melting point being taken as the peak of the melting endotherm, and the glass transition temperature as the middle of the transition. Such measurements can be done following ASTM method D3418.

Useful thermoplastics include polyolefins such as polyethylene, polypropylene and polystyrenes; poly(meth)acrylates such as poly(methyl methacrylate); polyesters such as poly(ethylene terephthalate), poly(1,4-butylene terephthalate) and poly(1,3-propylene terephthalate); polyamides such as nylon-6 and nylon-6,6; polyethers such as poly(phenylene oxides); polycarbonates; poly(ether-sulfones); poly(ether-imides); polysulfides such as poly(p-phenylene sulfide); liquid crystalline polymers such as aromatic polyesters, poly(ester-imides), and poly(ester-amides); poly(ether-etherketones); poly(ether-ketones); fluoropolymers such as polytetrafluoroethylene, a co-polymer of tetrafluoroethylene and perfluoro(methyl vinyl ether), a copolymer of tetrafluoroethylene and hexafluoropropylene, and a copolymer of ethylene and vinyl fluoride; poly(oxymethylene); poly(vinyl chloride); ABS (acrylonitrile-butadiene-styrene copolymer), and mixtures and blends thereof.

Preferably the thermoplastic polymer (or total of all thermoplastic polymers if more than one is present) is at least 40 volume percent, more preferably at least 60 volume percent, of the composition.

The carbon fiber which is used will generally be in the form of a chopped or short fiber, typically about 0.1 to about 6 mm long. The carbon fiber is preferably a fiber which has a relatively high carbon content (>90% by weight) and has (for carbon fiber) a relatively low electrical resistance. The fiber may be added directly to the thermoplastic polymer in an appropriate mixer (see below), or may be added in the form of a masterbatch. The composition herein contains about 5.0 to about 10.0 volume percent, preferably about 6.0 to about 9.0 volume percent of the carbon fiber. Herein all volume percents are based on the total volume of the composition, that is the volume of all the ingredients of the composition, including those that are not the carbon fiber, carbon black and thermoplastic(s) present.

The carbon black used may be any carbon black useful for mixing into thermoplastics. The carbon black may be added directly to the thermoplastic polymer in an appropriate mixer (see below), or may be added in the form of a masterbatch. The composition herein contains about 8 to about 25 volume percent, preferably about 10 to about 21 volume percent of the carbon black.

A preferred type of thermoplasti polymer is a liquid crystalline polymer (LCP). By a “liquid crystalline polymer” is meant a polymer that is anisotropic when tested using the TOT test or any reasonable variation thereof, as described in U.S. Pat. No. 4,118,372, which is hereby included by reference. Useful LCPs include polyesters, poly(ester-amides), and poly(ester-imides). One preferred form of polymer is all aromatic, that is all of the groups in the polymer main chain are aromatic (except for the linking groups such as ester groups), but side groups which are not aromatic may be present. Suitable thermotropic LCPs, for example, are described in U.S. Pat. Nos. 3,991,013, 3,991,014, 4,011,199, 4,048,148, 4,075,262, 4,083,829, 4,118,372, 4,122,070, 4,130,545, 4,153,779, 4,159,365, 4,161,470, 4,169,933, 4,184,996, 4,189,549, 4,219,461, 4,232,143, 4,232,144, 4,245,082, 4,256,624, 4,269,965, 4,272,625, 4,370,466, 4,383,105, 4,447,592, 4,522,974, 4,617,369, 4,664,972, 4,684,712, 4,727,129, 4,727,131, 4,728,714, 4,749,769, 4,762,907, 4,778,927, 4,816,555, 4,849,499, 4,851,496, 4,851,497, 4,857,626, 4,864,013, 4,868,278, 4,882,410, 4,923,947, 4,999,416, 5,015,721, 5,015,722, 5,025,082, 5,086,158, 5,102,935, 5,110,896, and 5,143,956, and European Patent Application 356,226.

The composition may contain other ingredients typically added to thermoplastics, such as fillers, reinforcing agents, plasticizers, flame retardants, antioxidants, antiozonants, lubricants, nucleating agents, in the amounts usually used for such compositions.

The ingredients for the composition may be mixed by methods typically used for preparing thermoplastic polymer containing compositions. For example the ingredients may be fed to a single or twin screw extruder in which the thermoplastic polymer(s) is melted and mixed with the other ingredients, including of course the carbon fiber and carbon black. Upon exiting the extruder the polymer may be formed into strands and cut into pellets for future use, or may be directly formed into shaped parts, as by feeding an injection molding machine. It is preferred that carbon fiber length (if not already relatively short) be attrited to an average length in the mixing process so that further processing (for example in molding) does not usually result in further shortening of the fiber length. Since the conductivity of the composition depends in part on the average fiber length of the carbon fiber, it is preferred that the surface resistivity of the composition not change substantially with further processing. However one does not want to shorten the carbon fibers to the point that they simply act like carbon powder or carbon black. Simple experimentation with the severity of the processing (for example screw configuration, screw speed, etc.) can determine how to carry this out.

Preferably the composition has a surface resistivity of about 10⁴ to about 10¹³ ohms/square, when measured by ASTM Method D257, more preferably about 10⁹ to about 10¹² ohms/square. One method of obtained the desired surface resistivity is carbon fibers are added to the polymer, and then enough carbon black, the amount easily determined by experimentation, is then added to decrease the surface resistivity to the value desired. By using this dual filler system, the surface resistivity can be adjusted to any value over a wide range. Surprisingly, when making the compositions described herein, the surface resistivity desired is relatively easily and reproducibly obtained in repeated manufacturing campaigns, some thing difficult to attain using a single electrically conductive filler. Molding conditions may also affect the surface resistivity of the parts made, but molding conditions to obtain the desired resistivity may be readily determined. For liquid crystalline polymers, which are anisotropic, it is preferred that the surface resistivities in both the machine and transverse direction be within the stated ranges.

The compositions herein are useful for parts where static dissipation and/or EMI shielding is desired. Such uses include cabinets for electronic equipment such as computers, automotive parts, copiers and printers.

### EXAMPLES 1-5 AND COMPARATIVE EXAMPLE A

The LCP used was the same as LCP-4 of U.S. Pat. No. 5,110,896, which is hereby included by reference. The carbon fiber (CF) used was Panex® 33CF carbon fiber (available from Zoltek Corp.), the glass fiber used (GF) was Owens Corning grade 408 Owens Corning Fiberglass, Toledo, Ohio, USA, the carbon black concentrate (CBC) was a master batch of 20 weight percent carbon black of LCP-9 of U.S. Pat. No. 5,110,896 and was obtained from Clarient Corporation, Charlotte, N.C., U.S.A.). Weights of each ingredient in each example are given in Table 1.

A Werner and Pfliederer 40 mm bilobal twin screw extruder was used to form the compositions. The LCP, CF, and carbon black concentrate were fed in the rear, and the glass fiber was side fed. The extruder has one unheated feed barrel (designated #1) and 9 heated barrels. The extruder screw design consisted of conveying elements with kneading elements added in barrel #3 to melt the polymer and mix the ingredients followed by a vacuum extraction zone in barrel #4. There was a side feeder in barrel #5, and following that there was a second set of kneading elements. There was a second vacuum extraction zone in barrel #8. The last barrel was equipped with a stranding die, and the melt strands were quenched in a water bath and fed into a strand cutter to make pellets approximately 0.32 cm in diameter and 0.32 cm long. The extruder barrel heat set points were 345° C., and the die heater set point was 350° C.

The pellets were dried overnight at 125° C. in an air oven and then molded into 0.32 cm thick bars. The injection molding machine was a 6 oz. HPM machine, with the mold temperature set at 65° C. or 110° C.

Surface electrical resistivities were measured using ASTM Method D-257 at room temperature, and are reported in Table 1 (CB is carbon black). Measurements were made in both the machine (flow) and transverse (perpendicular to flow) directions of the molded bars.

TABLE 1

| | LCP | | CBC | | | | | | | | | |
|---|---|---|---|---|---|---|---|---|---|---|---|---|
| | wt. | CF | wt. | GF | Vol. % | Vol. % | Vol. % | Vol. % | Mold | Surface Resistivity ohm/square | | |
| Ex. | % | wt. % | % | wt. % | LCP^{a} | CF | CB | GF | Temp, ° C. | Machine | | Transverse |
| 1 | 40 | 11 | 40 | 9 | 75.5 | 10 | 8.5 | 6.0 | 65 | 4.78 × | 10¹³ | 2.95 × 10¹³ |
| | | | | | | | | | 110 | 7.9 × | 10¹³ | 7.2 × 10¹³ |
| 2 | 40 | 9 | 40 | 11 | 75.9 | 8.2 | 8.5 | 7.4 | 65 | 2.16 × | 10¹³ | 3.23 × 10¹³ |
| | | | | | | | | | 110 | 8.2 × | 10¹³ | 1.5 × 10¹⁴ |
| A | 40 | 13 | 40 | 7 | 75.2 | 11.8 | 8.4 | 4.6 | 65 | 2.26 × | 10¹³ | 1.60 × 10¹³ |
| | | | | | | | | | 110 | — | | 1.6 × 10¹⁴ |
| 3 | 30 | 11 | 50 | 9 | 73.2 | 10.1 | 10.6 | 6.1 | 65 | 1.31 × | 10⁹ | 1.20 × 10¹⁰ |
| | | | | | | | | | 110 | 8.8 × | 10⁸ | 2.1 × 10⁹ |
| 4 | 20 | 11 | 60 | 9 | 70.9 | 10.2 | 12.8 | 6.1 | 65 | 7.26 × | 10⁴ | 9.90 × 10⁴ |
| | | | | | | | | | 110 | 1.5 × | 10⁵ | 1.5 × 10⁵ |
| 5 | 30 | 9 | 50 | 11 | 73.7 | 8.2 | 10.7 | 7.4 | 65 | 3.35 × | 10⁹ | 2.88 × 10⁹ |
| | | | | | | | | | 110 | 2.2 × | 10¹⁴ | 5.7 × 10¹³ |

^{a}Includes LCP in carbon black concentrate.

What is claimed is:

1. A composition, comprising, a thermoplastic polymer, about 5.0 to about 10 volume percent of carbon fiber, and about 8 to about 25 volume percent of carbon black, wherein said volume percentages are based on the total volume of said composition.

2. The composition as recited in claim 1 wherein said carbon fiber is about 6.0 to about 9.0 volume percent of said composition.

3. The composition as recited in claim 1 wherein said carbon fiber is about 0.1 mm to about 6.0 mm long.

4. The composition as recited in claim 1 wherein said carbon black is about 10 to about 21 percent by volume of said composition.

5. The composition as recited in claim 1 wherein said thermoplastic polymer is at least about 40 volume percent of said composition.

6. The composition as recited in claims 1 wherein said carbon fiber is about 6.0 to about 9.0 volume percent of said composition, said carbon fiber is about 0.1 mm to about 6.0 mm long, said carbon black is about 10 to about 21 percent by volume of said composition, and said thermoplastic polymer is at least about 40 volume percent of said composition.

7. The composition as recited in claim 1 wherein said thermoplastic is selected from the group consisting of polyolefins, poly(meth)acrylates, polyesters; polyamides, polycarbonates, poly(ether-sulfones); poly(ether-imides); polysulfides, liquid crystalline polymers, poly(ether-ether-ketones); poly(ether-ketones); fluoropolymers; poly(oxymethylene); poly(vinyl chloride); and ABS, and mixtures and blends thereof.

8. The composition as recited in claim 1 wherein said thermoplastic polymer is a liquid crystalline polymer.

9. The composition as recited in claim 1 which has a surface resistivity of about 10⁴ to about 10¹³ ohms/square.

10. The composition as recited in claim 1 which has a surface resistivity of about 10⁹ to about 10¹² ohms/square.
